(19) United States
(12) Patent Application Publication
(10) Pub. No.: US 2017/0246762 A1
(43) Pub. Date: Aug. 31, 2017

(54) METHOD AND APPARATUS FOR MANUFACTURING LIGHTWEIGHT CEMENT AND GYPSUM BOARD

(71) Applicant: INSOMAT LLC, Atlanta, GA (US)

(72) Inventor: NIKOLAY LYUBOMIROV NAYDENOV, SOFIA (BG)

(21) Appl. No.: 15/530,490

(22) PCT Filed: Jul. 10, 2015
(86) PCT No.: PCT/BG2015/000020

§ 371 Date: Jan. 23, 2017

(30) Foreign Application Priority Data
Jul. 22, 2014 (BG) 111794

(51) Int. Cl. B28B 13/02; C04B 14/20; C04B 28/14; C04B 14/38; B28B 17/02; B28B 19/00

(52) U.S. Cl. CPC B28B 13/021; B28B 17/023; B28B 13/0295; B28B 19/0092; C04B 28/14; C04B 14/38; C04B 14/20; C04B 2103/30

(57) ABSTRACT

A method and device for producing lightweight panels with a core of gypsum or of cement and gypsum, with pores for decreasing volumetric weight, and with a covering made of cardboard or of a sheet of glass fibers. The production line does not change except for the addition of a device which forms closed hollow cavities within a suspension in an area where an upper sheet covers the suspension. Air pressure which is fed into the formed cavities is slightly higher than the hydraulic pressure of the suspension, so as to prevent the gaps being filled by the suspension. The layers are less thick, and the type and dimensions of the cavities and the thickness of the walls are varied depending on the desired qualities of the panels.

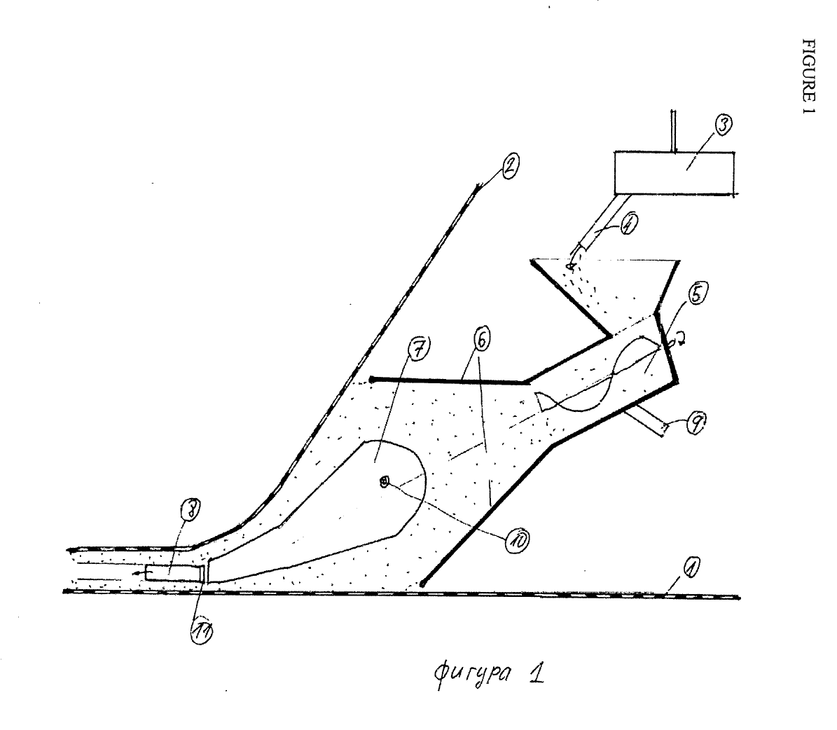

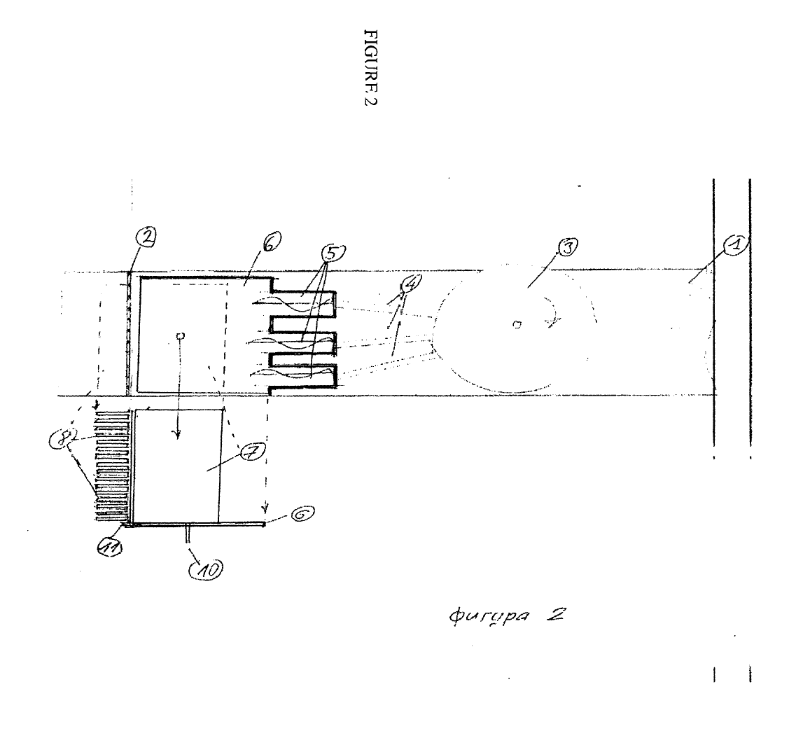

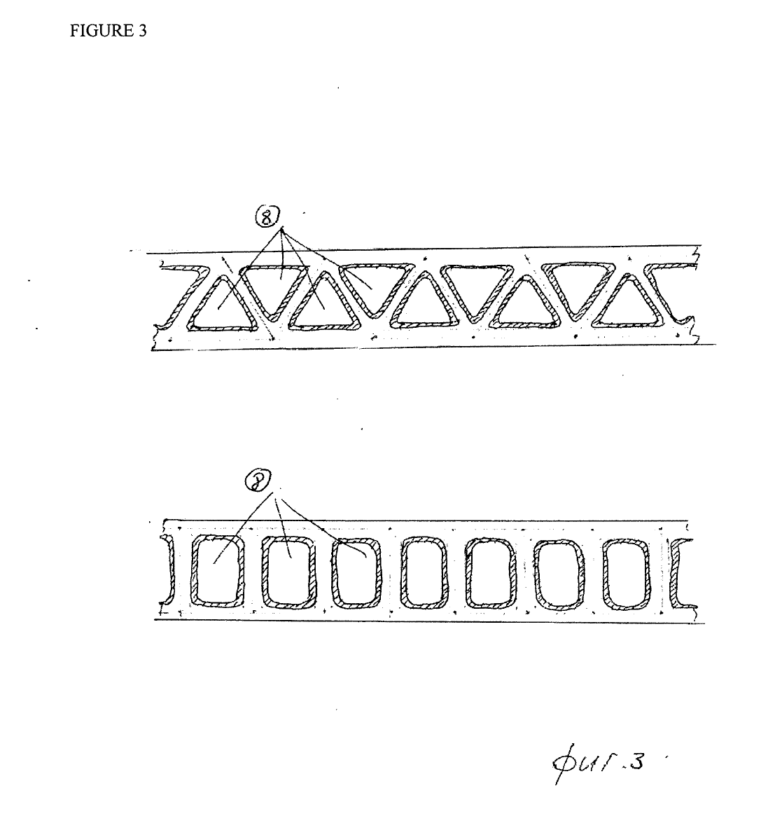

### TECHNICAL FIELD OF THE INVENTION

The present invention relates to gypsum and cement boards used in the construction of walls and ceilings, and in particular for lightweight panels. The invention also provides a device for performing the method of the invention for production of production lines with continuous operation.

### BACKGROUND OF THE INVENTION

Plasterboard and cement boards are used for interior and exterior walls and ceilings, as their main advantages are low cost, fire resistance and easy handling. Major drawback of conventional panels are large weight, which makes working with them tiresome for installers.

It is known to reduce the weight of the panel, by aeration to create pores. Is used for this foam or soap slurry to trap air or gas evolution from the carbon dioxide in the gypsum mixture, thereby creating a less dense core. However, the boards lack the necessary strength to be used for walls and ceilings. It is particularly low resistance of the Nail Withdrawal Strength. Other disadvantages of the use of foam is that the foaming agents generally interfere with the correct hydration, crystal growth of the gypsum and may deteriorate the adhesion between the core and paper.

There are other solutions to produce lightweight gypsum board by adding expanded volcanic ash or perlite. When heated, this material expands, forming a hollow, relatively watertight spheres. When these spheres are mixed with the gypsum creates, air pockets that reduce the density of the core. However, the panels do not have the necessary strength.

It is known is another solution for the production of lightweight boards with internal voids obtained by mechanically perforating the core, but this solution is not applicable in modern production lines with production speeds above 100 m/min.

The first objective of the present invention to provide an improved gypsum board and cement board, which are lighter but have the necessary stability Nail Withdrawal Strength. Another object of the present invention is to provide an improved method for the production of lightweight gypsum and cement boards on production lines with continuous operation.

### SUMMARY

The object of the invention is to provide a continuous process for the production of low weight, but with the necessary strength to the conventional boards, gypsum and cement boards, with an outer cover of cardboard or cloth of glass fibers.

The object of the invention to lighten the boards is achieved by a new device, which creates empty spaces enclosed in the core of boards. The new device is added to the existing high-speed production lines for plasterboard, without changing them. The resulting board has the necessary strength, because the walls between spaces of sufficient thickness.

Summary of the proposed method is that without changing the existing production line are mixed according to known recipes plaster, cement, fly ash and mixtures thereof with water, fiber, and optionally additives to form a free flowing slurry. Which enters the new device mounted above the moving lower sheet before covering the suspension with the second sheet. This new device extruded suspension as formed enclosed spaces inside. In the generated spaces entering air pressure slightly higher than the hydraulic pressure of the suspension to prevent the blank to be filled with suspension. From there, the production line does not change.

The apparatus of the present invention is mounted on the existing production lines for plasterboard continuous over moving lower sheet of cardboard or glass fiber mat/1/cover before the suspension with the second moving upper sheet of cardboard or glass fiber mat/2/. The suspension of PIN mixer/3/up to the new machine to the three existing sleeve/4/and poured into three new auger/5/, which it is injected into the new device, which is systole of a housing/6/, which is internally closed body/7/, which serves on the outside to evenly distribute the slurry and it spread in a uniform layer over the entire width of the production line and inside pressure reservoir of compressed air/1/. At the front end of a closed body/7/has arranged a small distance to each other oval tubes/8/in one or more of the lines of sizes and distances from one another adhere to the ceiling cavity to achieve the necessary strength gypsum board or cement board. At the lower end of the apparatus the slurry uniformly enter from below and from above and passes around the ordered oval pipe/8/, from which exits the air from the enclosed body/7/and fills the empty space that is obtained after the end of the pipes in the moving suspension enclosed between moving upper and lower leaf. Corpus/6/is mounted to the line of posture. Vertically is fixed so as to have a certain distance between the circular pipe and the bottom sheet/1/and the top sheet/2/. The housing/6/does not rely on moving upper and lower sheet.

When stopping the movement of the line for the device to be cleaned through nozzles/9/fed retardant binder suspension, such as citric acid. Cleaning device is disassembled by fast connections into two parts. The first part is housing/6/which remains in place on the stand, the second part is the internal body closed/7/with one vertical wall of the unit, which is exported perpendicular to the production line of telescopic stand. Thus ordered a small distance to each other oval tubes/8/are available and can be cleaned.

To reduce friction with the slurry inside the device is coated with a wear layer, e.g., Teflon or polyurethane. The oval tubes/8/for the one preferred is to be molded from a silicone polymer or a polyurethane to be flexible and non-adhesive for the suspension to be cleaned easily. For easy replacement of oval tubes/8/they have in common block/11/that is attached with a flange to the inner body closed/7/.

In order to improve the plasticity and forming a shape in the slurry is preferably to known recipes gypsum 20-96% Portland cement 0-70%, fly ash 0-50%, 0-3% lime, pozolan 0-40% fibrous reinforcement 0-3% supplements and 0.1-5% to 0.1-3% mica added.

1. The method for the production of lightweight boards with a core of gypsum, cement, fly ash and an outer cover of cardboard or mat of glass fibers using existing production lines for continuous production of gypsum board, which is produced first a liquid mixture of water and plaster, cement, finely ground gypsum crystal, recycled gypsum, and mixtures thereof, a plasticizer, frothers, fibers and other additives, characterized in that the production line, which does not change, add a new device, which forms a closed empty spaces in the interior of the slurry in the area where the top sheet covers the slurry as formed in spaces air is introduced at a pressure slightly higher than the hydraulic pressure of the slurry in order to prevent the blank to be filled with slurry.

2. The apparatus for producing lightweight gypsum is added to all production lines for plasterboard and is characterized that is placed over the bottom sheet feeding devices cardboard or fabric of glass fibers and devices before swearing an overlay paper or mat of glass fibers next to the mixer to the liquid ingredients through three new auger is pumped and spread in a even layer over the entire width of the production line, formed in closed spaces in the interior of the suspension means arranged one to the other oval tubes with size and distances from each other consistent with the maximum amount of cavities with vertical and/or diagonal walls in which accomplish the required strength, in oval pipes in reservoir pressure is fed pressurized air from the compressor unit is mounted on a stand vertically machine is fixed so that there is a certain distance between the cavities and the top and bottom sheet, the size of the thickness of the layer below, the width of the gap and the thickness of the thick walls of the suspension is made different for different necessary strength of the panels.

3. The apparatus is characterized in that it comprises a housing in which there is internally closed body, which serves on the outside to distribute the suspension in a uniform layer over the entire width of the production line, and its inner side is reservoir pressure air at the bottom of a closed body is attached with a flange arranged in a single block of small distances to and over another oval tubes, the suspension evenly enters from below and from above, passing around ordered oval pipes from which comes the pressurized air from the closed body and fills the empty space that is obtained after the end of the pipes in the moving suspension enclosed between the moving upper and lower sheet.

4. When braking the movement of the production line is cleaned characterized in that the screws through nozzles fed flame hardening of the slurry, for example, citric acid and the apparatus is disassembled into two parts relating to quick links, the first part is a corps, which stays in place on the stand, the second part is a vertical wall of the corps and closed the inner body, which is exported perpendicular to the production line of telescopic stand to be accessible for cleaning ordered a small distance to each other oval pipes.

5. The inside of the apparatus is characterized in that for reducing friction is coated with wear layer, for example, Teflon or polyurethane, and oval pipes are molded from a silicone polymer or a polyurethane to be easily cleaned from the suspension.

6. A liquid mixture for the production of lightweight boards with a core of gypsum or cement plaster, characterized in that to a known recipes for the production of gypsum and cement boards, gypsum 20-96% Portland cement 0-70%, fly ash 0-50%, 0-3% lime, pozzolan 0-40%, 0-3% fibrous reinforcement and other additives is added 0.1-3% mica to improve the plasticity of the suspension, which favors the formation of the closed spaces in the interior of the slurry.
